(19) United States
(12) Patent Application Publication
(10) Pub. No.: US 2026/0095319 A1
(43) Pub. Date: Apr. 2, 2026

(54) SEED PHRASE ENTRY FOR CRYPTO WALLETS

(71) Applicant: Thirdwayv, Inc., Irvine, CA (US)

(72) Inventors: Michael Atef Ayoub, Irvine, CA (US); Nabil Wasily, Foothill Ranch, CA (US)

(73) Assignee: Thirdwayv, Inc., Irvine, CA (US)

(21) Appl. No.: 19/107,507

(22) PCT Filed: Sep. 27, 2023
(86) PCT No.: PCT/US2023/033903

§ 371 Date: Feb. 27, 2025

Related U.S. Application Data
(60) Provisional application No. 63/412,354, filed on Sep. 30, 2022.

(51) Int. Cl. H04L 9/08; H04L 9/32

(52) U.S. Cl. CPC H04L 9/0894; H04L 9/3247; H04L 2209/56

(57) ABSTRACT

Cryptocurrency transactions are increasing in prevalence. An important security practice for cryptocurrency transactions includes maintaining a crypto wallet with a private key for signing cryptocurrency transactions. Hardware based crypto wallets with a secure element retaining the private key are highly secure. This disclosure provides a hardware based crypto wallet with a small form factor and a display screen for entering recovery seed phrases. The security of the display screen is enhanced via a novel data entry mechanism that does not require a separate processor but can be handled directly by a processor of a secure element.

### CROSS-REFERENCE TO RELATED APPLICATIONS

This application is based upon and claims the benefit and priority to U.S. Provisional Ser. No. 63/412,354 entitled “SEED PHRASE ENTRY MECHANISM ON A CRYPTO WALLET TOUCHSCREEN,” filed on Sep. 30, 2022, the entire content of which is incorporated herein by reference.

### FIELD

The present invention is directed to crypto wallets, and more specifically, the present disclosure is directed to seed phrase entry for crypto wallets.

### BACKGROUND

Crypto wallets are used to generate and store the cryptographic keys required for performing cryptocurrency transactions. The private keys of a crypto wallet are usually generated via a deterministic hierarchical scheme based on one master secret, called the seed value. The cryptographic seed value is important to maintain securely. If the seed value is leaked or compromised, a hacker may gain control of the crypto wallet and/or initiate unwanted transactions. At the same size, a wallet owner desires the ability to enter a recovery seed phrase to restore the wallet if access credentials are lost or if the wallet is required to be ported to a new wallet. However, recovery seed phrases often include a series of words that is tedious, frustrating, and time consuming to enter on conventional crypto wallets.

### SUMMARY

A crypto wallet device is provided. The crypto wallet device has a secure element with a processor and a memory. The secure element stores a master seed value of the crypto wallet device for use in cryptographic calculations. The crypto wallet device has a touch screen connected to the secure element and configured for data entry to enter a seed phrase into the secure element.

In various embodiments, the seed phrase corresponds to a set of words and each word is associated with at least a portion of a value. The combination of the portions of the value of the words of the set of words corresponds to the master seed value.

The memory of the secure element contains a dictionary of words corresponding to binary values, wherein the master seed value of the crypto wallet device may be recovered by entry of a series of words from the dictionary of words, the words made of characters and having a series of binary values corresponding to a recovery key phrase, the series of binary values corresponding to the master seed value.

The secure element generates visual representations of buttons having unique sets of characters associated with each button. A user selection of a button generates a first command, wherein the secure element retrieves from the dictionary in response to the first command, a set of words having at least one character of the unique set of characters associated with the button.

In various embodiments, the crypto wallet device does not have a physical keyboard. In various embodiments, the crypto wallet device does not have buttons. The touch screen may be controlled by the secure element, wherein the touch screen is not connected to any separate memory other than the secure element having the memory.

A method of entering recovery key phrases into a crypto wallet device. In various embodiments, a method of secure recovery key processing is provided. The method may be for secure recovery key processing by a crypto wallet device having a secure element comprising a processor and a memory and having a touch screen connected to the secure element. The method may include multiple steps. For instance, the method may include transmitting, by the secure element, a visual representation of a first set of buttons to the touch screen. The method may include receiving, by the touch screen, the visual representation of the first set of buttons. The method may include displaying, by the touch screen, the visual representation of the first set of buttons. Each button of the first set of buttons corresponds to a unique plurality of characters. The method may include receiving, by the touch screen, a first selection by a user of a first button of the first set of buttons. The unique plurality of characters associated with the first button is a first button character set. The method may include transmitting, by the touch screen, the first selection of the first button to the secure element. The method may include searching, by the processor of the secure element, the memory of the secure element to retrieve from a dictionary containing words, a first set of words. The first set of words may have a first character selected from among the first button character set and have no other first character. The method may include retrieving, by the processor of the secure element, the first set of words. The method may include transmitting, by the secure element, the first set of words to the touch screen. The method may include displaying, by the touch screen the first set of words. The method may include optionally receiving a user selection of a selected word from among the first set of words. In response to the receiving, the method may include comparing, by the processor of the secure element, the selected word to a recover key phrase of the crypto wallet device to determine whether the selected word matches at least a portion of the recovery key phrase. In response to the comparing indicating that the selected word matches the at least the portion of the recover key phrase, the method may include determining whether any remaining words of the recovery key phrase remain un-matched with further selected words received by receiving further user selections of the further selected words. In response to all remaining words of the recover key phrase matching with further selected words, the method may include restoring the wallet for use to sign cryptocurrency transactions with a private key of the secure element. In various embodiments of the method, no two buttons of the first set of buttons share any same character.

Furthermore, in response to not optionally receiving the user selection of the word, other elements may be performed. For instance, the method may include transmitting, by the secure element, a visual representation of a second set of buttons to the touch screen. The method may include receiving by the touch screen, the visual representation of the second set of buttons. The method may include displaying, by the touch screen, the visual representation of the second set of buttons. Each button of the second set of buttons corresponds to the unique plurality of characters. The method may include receiving, by the touch screen, a second selection by the user of a second button of the second set of buttons. The unique plurality of characters associated with the second button is a second button character set. The method may include transmitting, by the touch screen, the second selection of the second button to the secure element. The method may include searching, by the processor of the secure element, the memory of the secure element to retrieve from a dictionary containing words, a second set of words. The second set of words may have a second character selected from among the second button character set and also have the first character selected from among the first button character set. The method may include retrieving the second set of words by the processor of the secure element. The method may include transmitting by the secure element, the second set of words to the touch screen. The method may include removing, by the touch screen, the displaying of the first set of words and displaying, by the touch screen, the second set of words.

In various instances, the second set of buttons correspond only to characters appearing as a second character in at least one word of the first set of words. In various instances, the second set of buttons contains fewer buttons than the first set of buttons. In various instances, the second set of words is a subset of the first set of words. In various embodiments, no two buttons of the second set of buttons share any same character.

A computer-readable medium is also provided. The computer-readable medium may store instructions that when executed by a processor of a secure element of a crypto wallet device, cause the processor to perform a method of secure recovery key processing. The method may comprise that mentioned above.

### BRIEF DESCRIPTION OF THE FIGURES

A more complete understanding of the present invention may be derived by referring to the detailed description and claims when considered in connection with the Figures, where like reference numbers refer to similar elements throughout the Figures, and:

FIG. 1 is a diagram of components of a crypto wallet device, in accordance with various embodiments;

FIG. 2 is a diagram of aspects of a memory of a secure element of the crypto wallet device, in accordance with various embodiments;

FIGS. 3A-3E are diagrams of different screen displays of a crypto wallet device at different points during entry of a recovery seed phrase, in accordance with various embodiments; and

FIGS. 4A-4B depicts a method of secure recovery key processing by a crypto wallet device, in accordance with various embodiments.

### DETAILED DESCRIPTION

Crypto wallets are used to generate and store cryptographic keys required for performing cryptocurrency transactions. Crypto wallets include at least two common varieties. Software wallets are crypto wallets that are a smartphone or desktop application that stores the cryptographic keys and also manages incoming and outgoing transactions. Hardware wallets are crypto wallets that have an embedded device, such as a secure element (SE), that stores the private keys used for signing outgoing transactions. The hardware wallet communicates with a smartphone, desktop, or web application “watch-only wallet” that only stores the corresponding public keys of the hardware wallet's private keys. A watch-only wallet monitors incoming transactions and prepares unsigned outgoing transactions for the embedded device but cannot sign outgoing transactions. The embedded device verifies the transaction details, retrieves the applicable signing key, signs the transaction, and sends the signed transaction back to the smartphone, desktop, or web application to be broadcast to mining nodes.

Hardware crypto wallets are known to be more secure than software crypto wallets because the software crypto wallets coexist with other applications on a smartphone or desktop and thus the private keys are susceptible to software attacks on the shared platform, while the keys in a hardware crypto wallet never leave the embedded device. Access to hardware crypto wallet operations is often protected by a personal identification number (PIN) or sensed biometric such as a fingerprint or facial recognition.

Private keys of a crypto wallet may be generated via a deterministic hierarchical scheme based on one master secret. The master secret is called the seed value. This seed value is important and must be maintained securely. The private keys must also be maintained securely. Moreover, a user may, in some instances, be required to enter a PIN code associated with the crypto wallet to authorize various transactions. The PIN code should also be maintained securely.

In parallel with these security requirements, wallet users also desire operational convenience. Frequently it is convenient for a crypto wallet to be relatively small. However, a small crypto wallet has limited space for human-machine interface components. This can make entry of a recovery seed phrase (such as during restoration of a wallet) difficult.

In various instances, crypto wallet devices use BIP 39 or similar specifications to generate a recovery seed phrase to be able to restore the wallet if the wallet is lost or required to be ported to a new wallet device or application. The recovery seed phrase includes a series of English words (or another language), often between 12 and 24 words. The process of entering the recovery seed phrase to the device is tedious, frustrating, and time consuming. Some wallet devices only have a limited number of buttons, for instance, two buttons, for use in entering the phrase. Some wallet devices have a touch screen instead of buttons. While a touch screen is more convenient, the touch screen may be unsecure, because the touch screen typically requires a powerful processor and is difficult to be solely controlled by a secure element chip. This also typically requires that the seed phrase is stored in flash memory. This presents a risk that the recovery seed phrase can be stolen using a flash storage forgery attack or other hacking method. Thus, this disclosure provides for a novel word entry mechanism on a touch screen that is controlled by a secure element chip and not by a separate processor and memory.

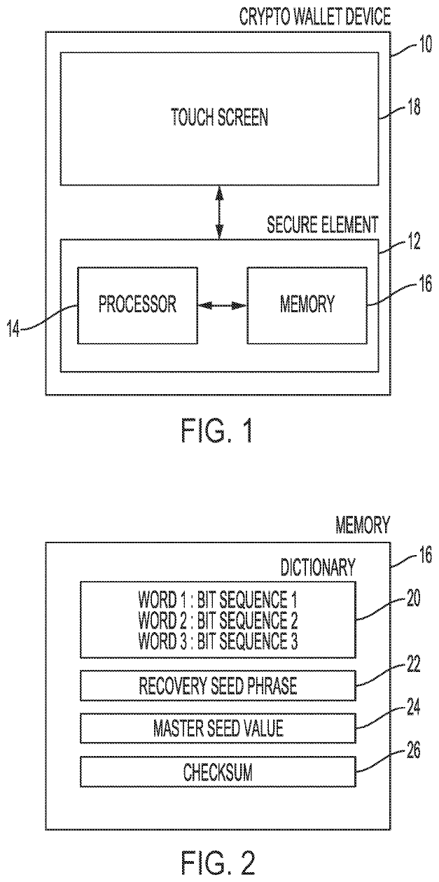

With reference to FIG. 1, a crypto wallet device 10 is illustrated. The crypto wallet device 10 may comprise a variety of different components. For example, the crypto wallet device 10 may include a secure element 12. A secure element (SE) is a tamper-resistant platform capable of securely hosting applications and their confidential and cryptograph data. For instance, a secure element 12 may have a memory 16 and a processor 14 for storage of seeds, or private keys and for execution of cryptographic operations with seeds or private keys. For instance, one or more of key pairs may be generated within the SE, for enhanced security, such that the key is hardware-backed and cannot be retrieved outside a SE. In various instances, one or more of the private keys are retained in a SE. This also facilitates improved security. By retaining the key within the SE, the key is secured from retrieval outside the SE, but may still be utilized for cryptographic operations. The secure element 12 may store a private key (seed phrase), parse a cryptocurrency transaction, generate a visible representation of the transaction to be presented to a user, and/or receive user confirmation via a push-button or other input connected to secure element 12. The secure element 12 may also control a touch screen 18 to allow secure entry of recovery seed phrases to restore a wallet without utilization of a separate touch screen processor or a separate touch screen memory.

As mentioned, the crypto wallet device 10 may include a touch screen 18. The touch screen 18 comprises a human-readable output display that can receive and display data from the secure element 12. The touch screen 18 also includes a touch sensitive digitizer that detects touches by a user and correlates a location of the touch to a location of elements of the displayed data on the human-readable output display so that a user may make selections of different displayed elements. The touch screen 18 then communicates those selections to the secure element 12.

Turning to FIG. 2, various data stored in the memory 16 of the secure element 12 are illustrated. The secure element 12 may store a master seed value 24. The master seed value 24 may be a series of bits that cryptographically relate to the private key and facilitate execution of cryptographic calculations. A check sum 26 may be included. The check sum 26 is a block of data derived from another block of data (“verification block”) for the purpose of detecting errors that may become introduced to the verification block. The check sum 26 may be derived from the master seed value 24 and may facilitate detection of errors in the master seed value 24. The memory 16 may store a recovery seed phrase 22. The memory 16 may store the recovery seed phrase 22 temporarily as working memory, or persistently as storage memory. The recovery seed phrase 22 is a series of words that can be correlated to bit sequences, that when combined, can derive the master seed value 24. Finally, the memory 16 may include a dictionary 20. The dictionary 20 may include a set of words that are correlated to bit sequences. In this manner, the dictionary 20 may include the full set of potential words potentially utilized in a recovery seed phrase 22.

Thus, with reference to the combination of FIGS. 1 and 2, a crypto wallet device 10 may include a touch screen 18 and a secure element 12 (or trusted execution environment) that includes a processor 14 and a memory 16. The touch screen 18 is controlled by the secure element 12 (or trusted execution environment). The secure element 12 stores a dictionary 20 of seed phrase words, where each word is mapped to a bit sequence of certain values. The touch screen 18 can accept a recovery seed phrase 22 as an input to the touch screen 18, which is provided to the secure element 12 by the touch screen 18. The secure element 12 maps the recovery seed phrase 22 to the crypto wallet device master seed value 24 and check sum 26 using the stored dictionary 20 of potential seed phrase words. The secure element 12 validates the check sum 26 attributed to the wallet's master seed value 24, and/or stores the restored wallet's master seed value 24 in the secure element 12 if the check sum 26 is validated successfully.

A novel word entry mechanism may be provided on the touch screen 18 to make entry of the recovery seed phrase 22 easier. The mechanism may comprise a plurality of touch buttons, where each touch button displays a plurality of alphabet letters. The word entry mechanism is configured, upon tapping a button, to map the tapped button to multiple possible values where the letters are attributed to the tapped button. The secure processor 14 is configured, upon tapping a sequence of buttons, to search the dictionary 20 for all seed phrase words whose first letter is one of the possible values attributed to the first tapped button, the second letter is one of the possible values attributed to the second tapped button, and so on. After each button is tapped, the secure processor 14 generates word suggestions that satisfy the criteria for all the buttons tapped for the same word. Given a sequence of buttons tapped for the same word, and if all the letters attributed to a button are inapplicable as the next letter, such a button is not displayed on the screen for the selection of the next letter. The mechanism continues until the required word is identified. The mechanism is repeated for all words of the recovery seed phrase 22.

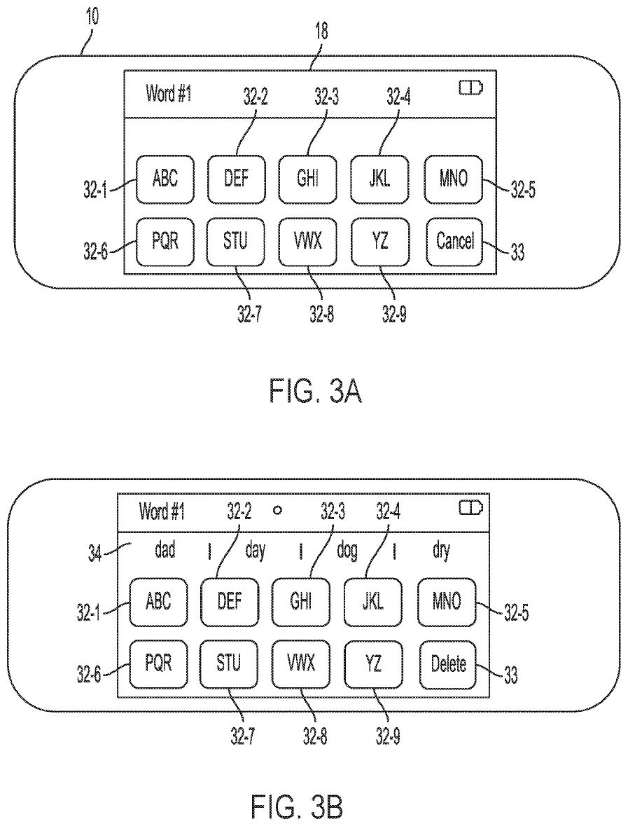

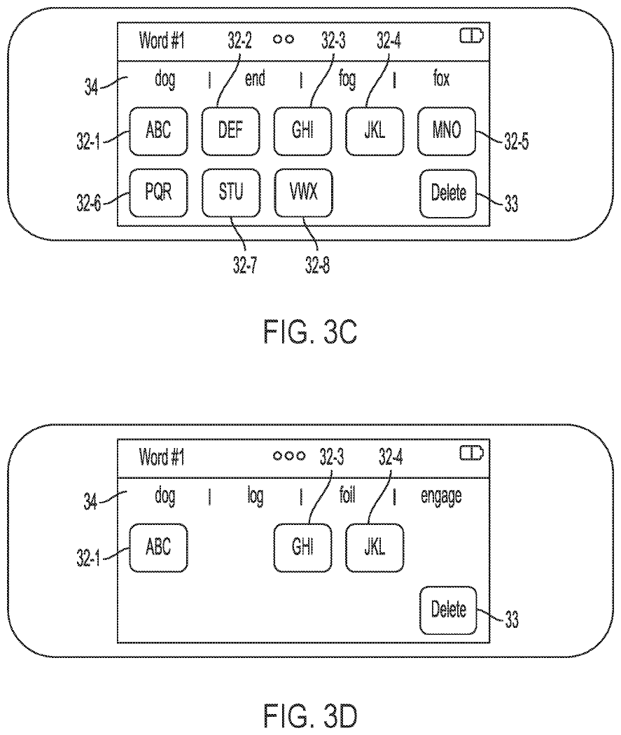

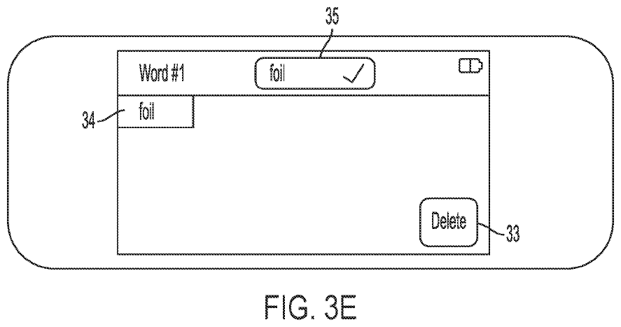

The sequence of FIGS. 3A-E shows an example series of touch screen displays generated by the secure element 12 during selection of buttons to enter words for a recovery seed phrase 22.

FIG. 3A illustrates a crypto wallet device 10 with a touch screen 18. On the touch screen 18 are various buttons 32 generated by the secure element 12 (FIG. 1). Each button 32 corresponds to multiple characters. For instance, a button 32-1 corresponds to “ABC,” a button 32-2 corresponds to “DEF,” a button 32-3 corresponds to “GHI,” a button 32-4 corresponds to “JKL,” a button 32-5 corresponds to “MNO,” a button 32-6 corresponds to “PQR,” a button 32-7 corresponds to “STU,” a button 32-8 corresponds to “VWX,” and a button 32-9 corresponds to “YZ.” A control button 33 is present to allow a user to cancel (e.g., delete) entry of characters.

The multiple touch buttons (button 32-1 through 32-9) are used to enter the recovery seed phrase 22. A group of letters is assigned to each button as indicated. A user may press button 32-2 corresponding to “DEF.” The device then searches the seed phrase dictionary 20 for all words whose first letter is either ‘D,’ ‘E,’ or ‘F.’ The button needs to be tapped only once. Turning to FIG. 3B, the device displays some word suggestions that satisfy the criteria in the suggestion region 34. If button 32-5 is pressed next, then the device searches the dictionary 20 for all words whose first letter is ‘D,’ ‘E,’ or ‘F,’ and whose second letter is ‘M,’ ‘N,’ or ‘O.’ Turning to FIG. 3C, the device displays a few word suggestions that satisfy the criteria in the suggestion region 34. Moreover, button 32-9 (FIG. 3B) corresponding to ‘Y,’ and ‘Z,’ disappears because there is no word in the seed phrase dictionary 20 with the first letter of ‘D,’ ‘E,’ or ‘F,’ and a second letter of ‘M,’ ‘N,’ or ‘O,’ and a third letter of ‘Y,’ or ‘Z.’

If the button 32-3 corresponding to ‘G,’ ‘H,’ and ‘I,’ is tapped next, the device searches the dictionary 20 for all words with the first letter of ‘D,’ ‘E,’ or ‘F,’ and a second letter of ‘M,’ ‘N,’ or ‘O,’ and a third letter of ‘G,’ ‘H,’ or ‘I.’ Turning to FIG. 3D, the device displays a few word suggestions that satisfy the criteria in the suggestion region 34. Further buttons 32-2 32-5, 32-6, 32-7, and 32-8 (FIG. 3C) with an inapplicable fourth letter also disappear. If the button 32-4 corresponding to ‘J,’ ‘K,’ and ‘L’ is tapped next, the list of word possibilities is further reduced. In this example, FIG. 3E shows that only one word in the dictionary 20 satisfies the overall criteria and appears in the suggestion region 34. If there are a few words that still satisfy the criteria, the user may tap one of the suggested words if the required word is displayed or continue to tap buttons of additional letter positions. If the word suggestions list reflects all the word possibilities that satisfy the criteria, then only the suggestions are shown on the screen and there is no need to show any buttons for selecting additional letters. Finally, the user confirms the word by tapping the blue confirmation rectangle 35. The mechanism moves on to the next word and returns to FIG. 3A. If the required word is displayed among the word suggestions at any point, such a word can be tapped, confirmed, and the mechanism moves on to the next word.

Referring now to the combination of FIGS. 1 and 2, it is convenient to discuss one example embodiment of the previously introduced crypto wallet device 10. A crypto wallet device 10 is provided. The crypto wallet device 10 has a secure element 12 with a processor 14 and a memory 16. The secure element 12 stores a master seed value 24 of the crypto wallet device 10 for use in cryptographic calculations. The crypto wallet device 10 has a touch screen 18 connected to the secure element 12 and configured for data entry to enter a recovery seed phrase 22 into the secure element 12.

In various embodiments, the recovery seed phrase 22 corresponds to a set of words and each word is associated with at least a portion of a value. The combination of the portions of the value of the words of the set of words corresponds to the master seed value 24.

The memory 16 of the secure element 12 contains a dictionary 20 of words corresponding to bit sequences (e.g., binary values), wherein the master seed value 24 of the crypto wallet device 10 may be recovered by entry of a series of words from the dictionary 20 of words, the words made of characters and having a series of binary values corresponding to a recovery key phrase 22, the series of binary values corresponding to the master seed value 24.

The secure element 12 generates visual representations of buttons having unique sets of characters associated with each button. A user selection of a button generates a first command, wherein the secure element 12 retrieves from the dictionary 20 in response to the first command, a set of words having at least one character of the unique set of characters associated with the button.

In various embodiments, the crypto wallet device 10 does not have a physical keyboard. In various embodiments, the crypto wallet device 10 does not have buttons. The touch screen 18 may be controlled by the secure element 12, wherein the touch screen 18 is not connected to any separate memory other than the secure element 12 having the memory 16.

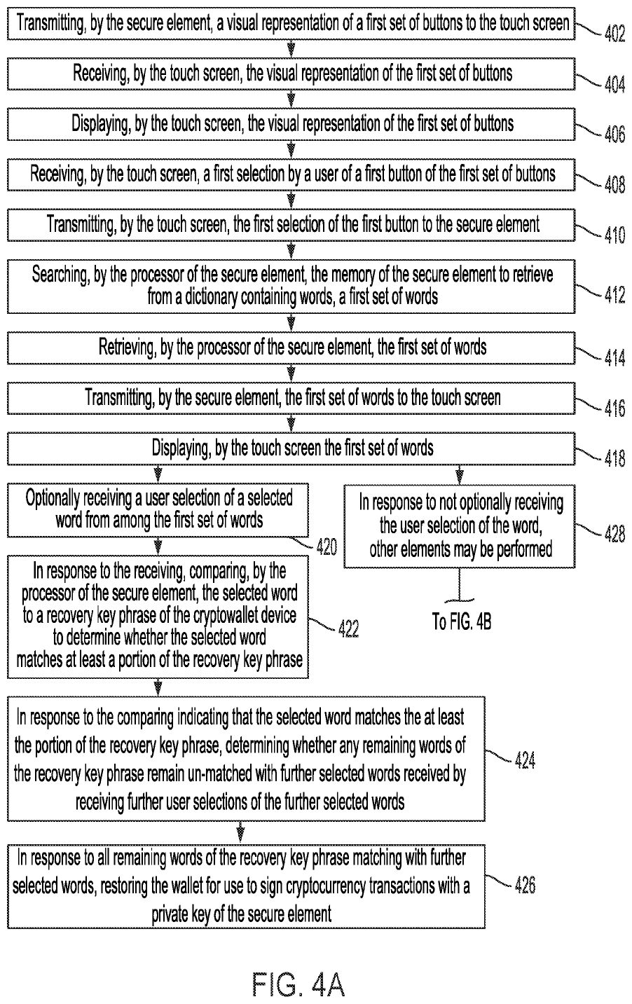

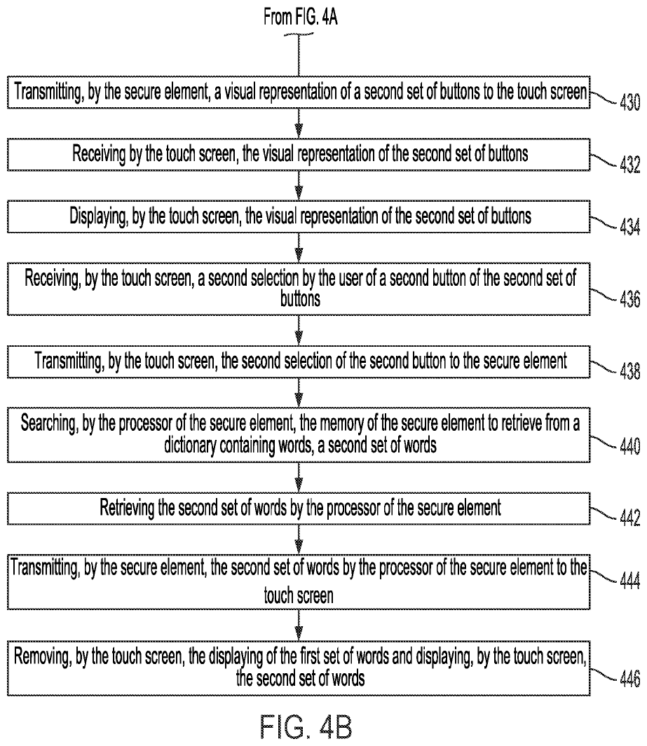

Referring now to FIGS. 4A-4B, it is convenient to discuss one example embodiment of the previously introduced method of entering recovery key phrases into a crypto wallet device 10. In various embodiments, a method 400 of secure recovery key processing is provided. The method may be for secure recovery key processing by a crypto wallet device having a secure element comprising a processor and a memory and having a touch screen connected to the secure element. The method may include multiple steps. For instance, the method may include transmitting, by the secure element, a visual representation of a first set of buttons to the touch screen (block 402). The method may include receiving, by the touch screen, the visual representation of the first set of buttons (block 404). The method may include displaying, by the touch screen, the visual representation of the first set of buttons (block 406). Each button of the first set of buttons corresponds to a unique plurality of characters. The method may include receiving, by the touch screen, a first selection by a user of a first button of the first set of buttons (block 408). The unique plurality of characters associated with the first button is a first button character set. The method may include transmitting, by the touch screen, the first selection of the first button to the secure element (block 410). The method may include searching, by the processor of the secure element, the memory of the secure element to retrieve from a dictionary containing words, a first set of words (block 412). The first set of words may have a first character selected from among the first button character set and have no other first character. The method may include retrieving, by the processor of the secure element, the first set of words (block 414). The method may include transmitting, by the secure element, the first set of words to the touch screen (block 416). The method may include displaying, by the touch screen, the first set of words (block 418). The method may include optionally receiving a user selection of a selected word from among the first set of words (block 420). In response to the receiving, the method may include comparing, by the processor of the secure element, the selected word to a recover key phrase of the crypto wallet device to determine whether the selected word matches at least a portion of the recovery key phrase (block 422). In response to the comparing indicating that the selected word matches the at least the portion of the recover key phrase, the method may include determining whether any remaining words of the recovery key phrase remain un-matched with further selected words received by receiving further user selections of the further selected words (block 424). In response to all remaining words of the recover key phrase matching with further selected words, the method may include restoring the wallet for use to sign cryptocurrency transactions with a private key of the secure element (block 426). In various embodiments of the method, no two buttons of the first set of buttons share any same character.

Furthermore, returning to block 418 and 420, in response to not optionally receiving the user selection of the word, other elements may be performed (block 428). For instance, the method may include transmitting, by the secure element, a visual representation of a second set of buttons to the touch screen (block 430). The method may include receiving by the touch screen, the visual representation of the second set of buttons (block 432). The method may include displaying, by the touch screen, the visual representation of the second set of buttons (block 434). Each button of the second set of buttons corresponds to the unique plurality of characters. The method may include receiving, by the touch screen, a second selection by the user of a second button of the second set of buttons (block 436). The unique plurality of characters associated with the second button is a second button character set. The method may include transmitting, by the touch screen, the second selection of the second button to the secure element (block 438). The method may include searching, by the processor of the secure element, the memory of the secure element to retrieve from a dictionary containing words, a second set of words (block 440). The second set of words may have a second character selected from among the second button character set and also have the first character selected from among the first button character set. The method may include retrieving the second set of words by the processor of the secure element (block 442). The method may include transmitting by the secure element, the second set of words to the touch screen (block 444). The method may include removing, by the touch screen, the displaying of the first set of words and displaying, by the touch screen, the second set of words (block 446).

In various instances, the second set of buttons correspond only to characters appearing as a second character in at least one word of the first set of words. In various instances, the second set of buttons contains fewer buttons than the first set of buttons. In various instances, the second set of words is a subset of the first set of words. In various embodiments, no two buttons of the second set of buttons share any same character.

The present disclosure has been described with reference to various embodiments. However, one of ordinary skill in the art appreciates that various modifications and changes can be made without departing from the scope of the present disclosure. For example, features of different embodiments may be combined. Accordingly, the specification is to be regarded in an illustrative rather than a restrictive sense, and all such modifications are intended to be included within the scope of the present disclosure.

The description is of various exemplary embodiments only, and is not intended to limit the scope, applicability, or configuration of the present disclosure in any way. Rather, the description is intended to provide a convenient illustration for implementing various embodiments including the best mode. As has become apparent, various changes may be made in the function and arrangement of the elements described in these embodiments without departing from the scope of the appended claims.

For the sake of brevity, conventional techniques for manufacturing and construction may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical method of construction. As used herein, mechanical communication means any joint, connection, bond, or arrangement whereby an article is held, retained, or fixed in relatively static spatial relationship to another article. As used herein, electronic communication means any wired, wireless, analog, digital, or other mechanism whereby information is communicated between machines, circuits, or devices.

Benefits, other advantages, and solutions to problems have been described herein with regard to various embodiments. However, the benefits, advantages, solutions to problems, and any elements that may cause any benefit, advantage, or solution to occur or become more pronounced are not to be construed as critical, required, or essential features or elements of the invention. Moreover, where a phrase similar to “at least one of A, B, and C” or “at least one of A, B, or C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

As used herein, the singular forms “a,” “an,” and “the” include plural referents unless the context clearly dictates otherwise. As used herein, the terms “for example,” “for instance,” “such as,” or “including” are meant to introduce examples that further clarify more general subject matter. Unless otherwise specified, these examples are embodiments of the present disclosure, and are not meant to be limiting in any fashion.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A crypto wallet device comprising:
a secure element comprising a processor and a memory, the secure element storing a master seed value of the crypto wallet device for use in cryptographic calculations; and
a touch screen connected to the secure element and configured for data entry to enter a recovery seed phrase into the secure element to recover the master seed value of the crypto wallet device.

2. The crypto wallet device of claim 1,
wherein the recovery seed phrase corresponds to a set of words, each word associated with at least a portion of a value, and
wherein the combination of the portions of the value of the words of the set of words corresponds to the master seed value.

3. The crypto wallet device of claim 1,
wherein the memory of the secure element further contains a dictionary of words corresponding to binary values, and
wherein the master seed value of the crypto wallet device may be recovered by entry of a series of words from the dictionary of words, the words made of characters and having a series of binary values corresponding to a recovery key phrase, the series of binary values corresponding to the master seed value.

4. The crypto wallet device of claim 3, wherein the secure element generates visual representations of buttons having unique sets of characters associated with each button.

5. The crypto wallet device of claim 4,
wherein a user selection of a button generates a first command, and
wherein the secure element retrieves from the dictionary in response to the first command, a set of words having at least one character of the unique set of characters associated with the button.

6. The crypto wallet device of claim 1, wherein the crypto wallet device does not have a physical keyboard.

7. The crypto wallet device of claim 1,
wherein the touch screen is controlled by the secure element, and
wherein the touch screen is not connected to any separate memory other than the secure element having the memory.

8. The crypto wallet device of claim 1, wherein the crypto wallet device does not have buttons.

9. A method of secure recovery key processing by a crypto wallet device having a secure element comprising a processor and a memory, and having a touch screen connected to the secure element, the method comprising:
transmitting, by the secure element, a visual representation of a first set of buttons to the touch screen;
receiving, by the touch screen, the visual representation of the first set of buttons;
displaying, by the touch screen, the visual representation of the first set of buttons,
wherein each button of the first set of buttons corresponds to a unique plurality of characters;
receiving, by the touch screen, a first selection by a user of a first button of the first set of buttons, wherein the unique plurality of characters associated with the first button is a first button character set;
transmitting, by the touch screen, the first selection of the first button to the secure element;
searching, by the processor of the secure element, the memory of the secure element to retrieve from a dictionary containing words, a first set of words having a first character selected from among the first button character set and having no other first character;
retrieving, by the processor of the secure element, the first set of words;
transmitting, by the secure element, the first set of words to the touch screen;
displaying, by the touch screen the first set of words;
optionally receiving a user selection of a selected word from among the first set of words;
in response to the receiving, comparing, by the processor of the secure element, the selected word to a recover key phrase of the crypto wallet device to determine whether the selected word matches at least a portion of the recovery key phrase;
in response to the comparing indicating that the selected word matches the at least the portion of the recovery key phrase, determining whether any remaining words of the recovery key phrase remain un-matched with further selected words received by receiving further user selections of the further selected words; and
in response to all remaining words of the recover key phrase matching with further selected words, restoring the wallet for use to sign cryptocurrency transactions with a private key of the secure element.

10. The method of secure recovery key processing according to claim 9, wherein no two buttons of the first set of buttons share any same character.

11. The method of secure recovery key processing according to claim 9, the method further comprising:
in response to not optionally receiving the user selection of the word:
transmitting, by the secure element, a visual representation of a second set of buttons to the touch screen,
receiving, by the touch screen, the visual representation of the second set of buttons;
displaying, by the touch screen, the visual representation of the second set of buttons,
wherein each button of the second set of buttons corresponds to the unique plurality of characters;
receiving, by the touch screen, a second selection by the user of a second button of the second set of buttons,
wherein the unique plurality of characters associated with the second button is a second button character set;
transmitting, by the touch screen, the second selection of the second button to the secure element;
searching by the processor of the secure element, the memory of the secure element to retrieve from a dictionary containing words, a second set of words having a second character selected from among the second button character set and also having the first character selected from among the first button character set;
retrieving the second set of words by the processor of the secure element;
transmitted, by the secure element, the second set of words to the touch screen; and
removing, by the touch screen, the displaying of the first set of words and displaying, by the touch screen, the second set of words.

12. The method of secure recovery key processing according to claim 11, wherein the second set of buttons correspond only to characters appearing as a second character in at least one word of the first set of words.

13. The method of secure recovery key processing according to claim 11, wherein the second set of buttons contains fewer buttons than the first set of buttons.

14. The method of secure recovery key processing according to claim 11, wherein the second set of words is a subset of the first set of words.

15. The method of secure recovery key processing according to claim 11, wherein no two buttons of the second set of buttons share any same character.

16. A computer-readable medium storing instructions that when executed by a processor of a secure element of a crypto wallet device, cause the processor to perform a method of secure recovery key processing, the method comprising:
transmitting, by the secure element, a visual representation of a first set of buttons to a touch screen;
receiving, by the touch screen, the visual representation of the first set of buttons;
displaying, by the touch screen, the visual representation of the first set of buttons,
wherein each button of the first set of buttons corresponds to a unique plurality of characters;
receiving, by the touch screen, a first selection by a user of a first button of the first set of buttons, wherein the unique plurality of characters associated with the first button is a first button character set;
transmitting, by the touch screen, the first selection of the first button to the secure element;
searching, by the processor of the secure element, the memory of the secure element to retrieve from a dictionary containing words, a first set of words having a first character selected from among the first button character set and having no other first character;
retrieving, by the processor of the secure element, the first set of words;
transmitting, by the secure element, the first set of words to the touch screen;
displaying, by the touch screen, the first set of words;
optionally receiving a user selection of a selected word from among the first set of words;
in response to the receiving, comparing, by the processor of the secure element, the selected word to a recovery key phrase of the crypto wallet device to determine whether the selected word matches at least a portion of the recovery key phrase;
in response to the comparing indicating that the selected word matches the at least the portion of the recovery key phrase, determining whether any remaining words of the recovery key phrase remain un-matched with further selected words received by receiving further user selections of the further selected words; and
in response to all remaining words of the recover key phrase matching with further selected words, restoring the wallet for use to sign cryptocurrency transactions with a private key of the secure element.

17. The computer readable medium according to claim 16, wherein no two buttons of the first set of buttons share any same character.

18. The computer readable medium according to claim 16, wherein the method further comprises:
in response to not optionally receiving the user selection of the word:
transmitting, by the secure element, a visual representation of a second set of buttons to the touch screen;
receiving, by the touch screen, the visual representation of the second set of buttons;
displaying, by the touch screen, the visual representation of the second set of buttons,
wherein each button of the second set of buttons corresponds to the unique plurality of characters;
receiving, by the touch screen, a second selection by the user of a second button of the second set of buttons,
wherein the unique plurality of characters associated with the second button is a second button character set;
transmitting, by the touch screen, the second selection of the second button to the secure element;
searching, by the processor of the secure element, the memory of the secure element to retrieve from a dictionary containing words, a second set of words having a second character selected from among the second button character set and also having the first character selected from among the first button character set;
retrieving the second set of words, by the processor of the secure element;
transmitted, by the secure element, the second set of words to the touch screen; and
removing, by the touch screen, the displaying of the first set of words and displaying, by the touch screen, the second set of words.

19. The computer readable medium according to claim 18, wherein the second set of buttons correspond only to characters appearing as a second character in at least one word of the first set of words.

20. The computer readable medium according to claim 18, wherein the second set of buttons contains fewer buttons than the first set of buttons.
